(19) United States
(12) Patent Application Publication
(10) Pub. No.: US 2011/0093509 A1
(43) Pub. Date: Apr. 21, 2011

(54) COMMON INTERACTION LOG REPOSITORY WITH ADVANCED CONTENT MANAGEMENT CAPABILITIES

(75) Inventors: James FAN, San Ramon, CA (US); Jennifer K. LAM, Fremont, CA (US); Adrian VULPAS, Shorewood, WI (US)

(73) Assignee: AT&T INTELLECTUAL PROPERTY I, L.P., Reno, NV (US)

(21) Appl. No.: 12/580,448

(22) Filed: Oct. 16, 2009

(51) Int. Cl. G06F 3/01; G06F 17/30

(52) U.S. Cl. 707/803; 715/745; 707/E17.005

(57) ABSTRACT

A communication is received at a communications center, from a user initiated via a first interactive session over a first service channel. First interaction data associated with the first interactive session is stored in at least one database, either concurrently with the first interactive session or upon termination of the first interactive session. At least one processor retrieves the first interaction data when a subsequent interactive session is initiated, by either of the user or an agent, via at least one of the first service channel and a second service channel and subsequent interaction data is obtained.

### BACKGROUND

1. Field of the Disclosure

The present disclosure relates to the field of data collection, retrieval and correlation. More particularly, the present disclosure relates to systems and methods for maintaining a common interaction log repository with advanced content management capabilities.

2. Background Information

Service providers offer service channels implementing self-service capabilities for customers to inquire about products, services, bills, as well as to report issues with a product or service. A service channel generally refers to underlying media and/or communications protocols that are used to implement these self-service capabilities. Self-service channels include an interactive voice response system, email exchanges and Internet-enabled web submission forms. Dialogs are captured over these self-service channels and document interactions between a customer and an automated or unmanned system. Agent-enabled service channels generally refer to service channels that are serviced by an automated or a human agent. Aspects of these interactions include user inputs, automated system actions, data used to verify or validate a customer, data used to conduct the dialog and data records stored by the automated system.

### BRIEF DESCRIPTION OF THE DRAWINGS

FIG. 1 shows an exemplary general computer system that includes a set of instructions for maintaining a common interaction log repository with advanced content management capabilities;

FIG. 2 shows a system diagram for maintaining a common interaction log repository with advanced content management capabilities, according to an aspect of the present disclosure;

FIG. 3 shows a process flow diagram for maintaining a common interaction log repository with advanced content management capabilities, according to a first embodiment of the present disclosure; and

FIG. 4 shows a process flow diagram for maintaining a common interaction log repository with advanced content management capabilities, according to a second embodiment of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, a method for managing communications received at a communications center includes receiving at the communications center, a communication from a user initiated via a first interactive session over a first service channel. The method includes storing, in at least one database, first interaction data associated with the first interactive session, either concurrently with the first interactive session or upon termination of the first interactive session. The method includes retrieving, by at least one processor, the first interaction data when a subsequent interactive session is initiated, by either of the user or an agent, via at least one of the first service channel and a second service channel and subsequent interaction data is obtained.

According to another aspect of the present disclosure, an interactive dialog initiated in the first interactive session is resumed in the subsequent interactive session.

According to yet another aspect of the present disclosure, correlating the first interaction data with the subsequent interaction data when the subsequent interaction data is obtained prior to expiration of a timer associated with the first interaction data.

According to still another aspect of the present disclosure, the first service channel comprises a self-service channel, and the second service channel comprises an agent-enabled service channel.

According to an aspect of the present disclosure, the user switches between the first interactive session and the subsequent interactive session.

According to another aspect of the present disclosure, the method includes merging the first interaction data with the subsequent interaction data in the at least one database.

According to yet another aspect of the present disclosure, the self-service channel is one of: an interactive voice response system service channel, an email submission service channel, and a web form submission service channel, and the agent-enabled service channel is one of: an agent-enabled chat client and an agent-enabled telephone call.

According to still another aspect of the present disclosure, the method includes bridging the first interactive session with the subsequent interactive session, when the subsequent interactive session is initiated concurrently with the first interactive session.

According to an aspect of the present disclosure, the method includes storing accumulated interaction data in a historical interaction database upon expiration of a timer and the accumulated interaction data comprises the first interaction data and the subsequent interaction data.

According to another aspect of the present disclosure, the method includes searching the historical interaction database, concurrently with servicing a subsequent communication received at the communications center to obtain interaction data related to a subject of the subsequent communication.

According to yet another aspect of the present disclosure, the method includes preparing an interactive dialog for at least one of a self-service channel and an agent-enabled service channel based on the interaction data related to the subject of the subsequent communication.

According to still another aspect of the present disclosure, the first interaction data and the subsequent interaction data each comprise at least one of: user input, system data, agent input and a user artifact.

According to an aspect of the present disclosure, system data comprises at least one of: data retrieved by an application supporting at least one of the first service channel and the second service channel, data generated by the application, data obtained from a test performed by at least one of the first service channel and the second service channel, and data obtained from a test triggered by at least one of the first service channel and the second service channel during at least one of the first interactive session and the second interactive session.

According to another aspect of the present disclosure, the user artifact comprises at least one of: a video file, an audio recording, a data file and an image file.

According to yet another aspect of the present disclosure, the first interactive session terminates prior to resolving a subject of the communication, and the subsequent interactive session is initiated by the user to resume the communication initiated in the first interactive session.

According to still another aspect of the present disclosure, the first interactive data and the second interactive data are each editable during a predetermined period of time, and the first interactive data and the subsequent interactive data are each reviewable after the predetermined period of time.

According to an aspect of the present disclosure, the method includes updating the first interactive data with the subsequent interactive data in the at least one database.

According to another aspect of the present disclosure, correlating the first interaction data with the subsequent interaction data precludes unnecessary record retrieval for the user.

According to an aspect of the present disclosure, a system for managing communications received at a communications center includes a receiver that receives, at the communications center, a communication from a user initiated via a first interactive session over a first service channel. The system includes at least one database, that stores first interaction data associated with the first interactive session, either concurrently with the first interactive session or upon termination of the first interactive session. The system includes a retriever that retrieves the first interaction data when a subsequent interactive session is initiated, by either of the user or an agent, via at least one of the first service channel and a second service channel and subsequent interaction data is obtained.

According to an aspect of the present disclosure, a tangible computer readable medium, that stores a computer program for managing communications received at a communications center includes a receiving code segment, recorded on the tangible computer readable medium, that receives at the communications center, a communication from a user initiated via a first interactive session over a first service channel. The tangible computer readable medium includes a storing code segment, recorded on the tangible computer readable medium, that stores, in at least one database, first interaction data associated with the first interactive session over the first service channel, either concurrently with or upon termination of the first interactive session. The tangible computer readable medium includes a retrieving code segment, recorded on the tangible computer readable medium, that retrieves, by at least one processor, the first interaction data when a subsequent interactive session is initiated, by either of the user or an agent, via at least one of the first service channel and a second service channel and subsequent interaction data is obtained.

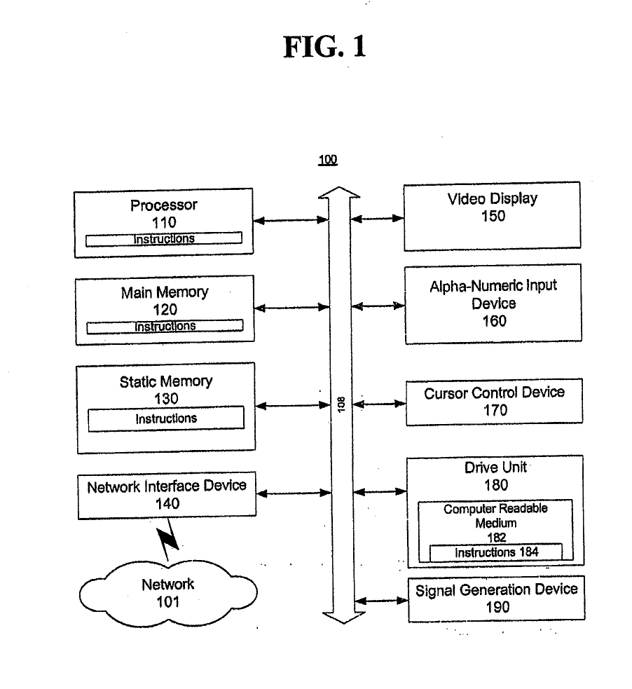

FIG. 1 is an illustrative embodiment of a general computer system, on which a method to provide selective logging based on a set parameter can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 126, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

FIG. 1 is an illustrative embodiment of a general computer system, on which a method of selective logging based on a set parameter, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

In a system implemented at a communications system, when a customer interacts via an Internet-enabled service channel, the customer's interactive session may not be logged and accordingly, may not be accessible by the customer. According to a first aspect of the present disclosure, interactive data is logged for each service channel, self-service or agent-enabled, over which a customer communicates with a communications center. Moreover, data is exchanged among one or more currently active interactive sessions, over the same type or different types service channels. Further, data collected among multiple interactive sessions (that have terminated) is exchanged among one or more service channels, irrespective of whether the service channels are self-service or agent-enabled.

One aspect of the present disclosure is illustrated by the following example. If the customer uses an interactive voice response system to initiate an interactive session but hangs up prior to completing the interactive session and subsequently calls back, the customer does not have to repeat the same process/steps as in the previously initiated session. If a customer uses the interactive voice response system service channel to start the interactive session but wishes to switch to an Internet-enabled service channel, he or she is not required to restart the interactive session dialog. Similarly, if the customer uses an Internet-enabled service channel to start the interactive session but abandons it, he or she is not required to restart the interactive session dialog when resuming an interactive session. If a customer uses an Internet-enabled service channel to start an interactive session but wants to switch to an interactive voice response system service channel, the customer need not restart the interactive session dialog when contacting a communications center via the interactive voice response system service channel.

Another aspect of the present disclosure includes that the interactive session initiated over the interactive voice response system service channel and the interactive session initiated over the Internet-enabled service channel is logged in a common repository using a common data schema. The customer is enabled to review data stored during a current interactive session or data stored during a previous interactive session. Further, the customer is enabled to resume a previous interactive session from a point at which the interactive session was abandoned. Moreover, the customer is enabled to resume the previous interactive session via the same service channel (e.g., the interactive voice response system service channel) or via a different service channel (e.g., the Internet-enabled service channel).

Yet another aspect of the present disclosure includes support for attaching a customer's artifacts (e.g., image files, text files, data files, video recordings and audio recordings); attaching system data (e.g., data files) retrieved and/or generated by an application that implements self-service capabilities for the self-service channel or that supports an agent-enabled channel; attaching system data (e.g., data files) resulting from tests performed or triggered by the service channel during an interactive session; managing and arranging interactive dialogs having a large volume; and correlating interactive dialogs among different customers.

According to one aspect of the present application, a “recording” of an interactive session (interchangeably termed as “interactive data”, “interaction data” or “data associated with an interactive session” herein) is used to optimize a customer's transition from a self-service channel to an agent-enabled service channel by reducing agent hold time. Agent hold time is reduced by avoiding repetition of an interactive session dialog (interchangeably termed “interactive dialog” herein) and reducing or eliminating unnecessary retrieval of customer records previously obtained during a first interactive session.

According to another aspect of the present disclosure, data associated with interactive sessions or interaction dialogs used by a human agent or automated agent and/or system during the interactive session (initiated over a number of different types of service channels) is correlated. Service channels are either self-service or agent-enabled. Self-service channels include any of the following, but are not limited to: interactive voice response systems, emails communications and Internet-enabled web form submissions. Agent-enabled access channels include any of the following, but are not limited to: Internet-enabled chat sessions with an agent, as well as calls, to a communications center, serviced by an agent.

In one embodiment, interaction data includes attachments (e.g., image files, data files, audio recordings, text files, video files, screen captures, and recordings from a unified communication server). Interactive tools are used to capture, process and analyze the interaction data and to present the interaction data in a form useful for decision-making to improve dialog management and to infer ways to improve products, services and support operations. Interaction data associated with one or more type of service channel and historical interaction data is used to optimize a current interactive session, for example, by modifying a self-service channel interactive dialog or an agent interactive dialog.

Interaction data for each service channel is captured and stored in one or more databases. In one embodiment, interaction data from a number of different interactive sessions are stored together in the one or more databases. In another embodiment, different interactive sessions occur over a number of different types of service channels. Accordingly, it is possible to create, read, update and delete a number of interactive sessions, as well the data associated with these interactive sessions; that is, it is possible to manage the lifecycle of the data associated with these interactive sessions. When a user prematurely ends an interactive session, that is, prior to resolution of an issue or an inquiry, the present disclosure contemplates resuming contact via the same type of self-service channel; resuming contact via another type of self-service channel (e.g., transferring from an interactive voice response system interactive session to a Internet-enabled interactive session and vice versa); resuming contact via an agent-enabled service channel (e.g., transferring from an interactive voice response system interactive session to a human agent-enabled interactive session and vice versa).

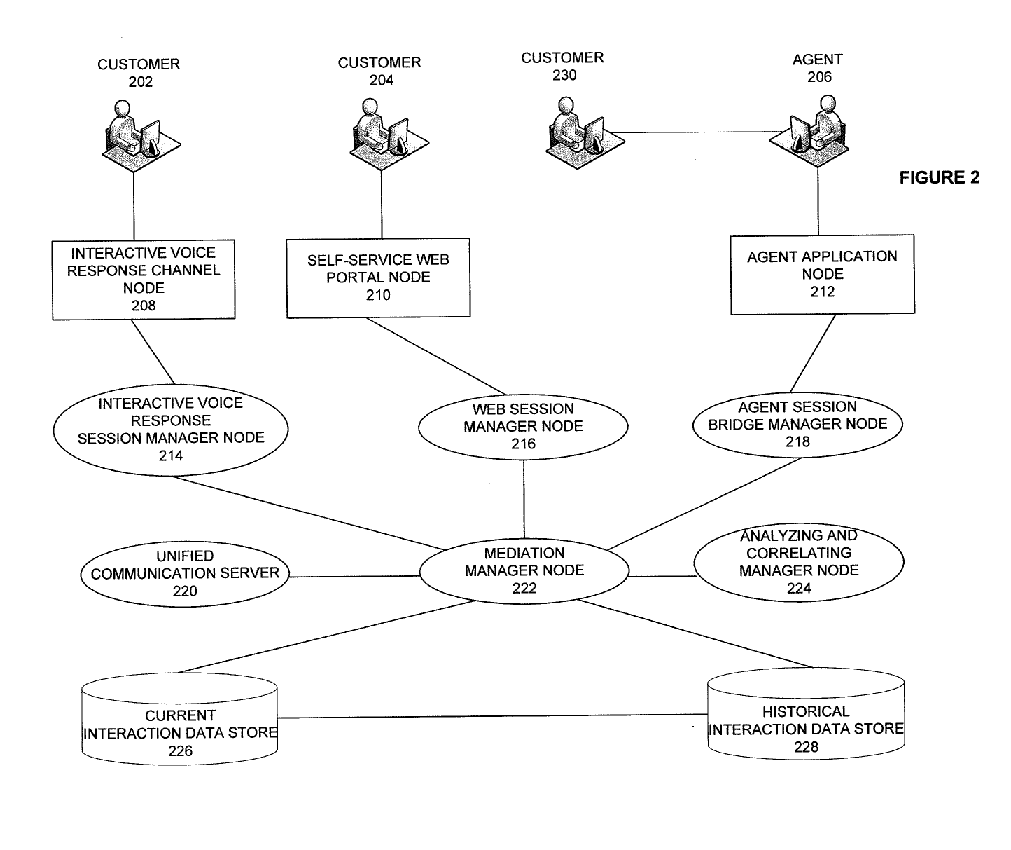

In FIG. 2, a system diagram of the present disclosure is shown. The interactive voice response channel node 208, self-service web portal node 210, agent application node 212, interactive voice response session manager node 214, web session manger node 216, agent session bridge manager node 218, mediation manager node 222 and analyzing and correlating manager node 224, which are described in detail below, are any tangible physical device upon which a software application is implementable. For example, a node is any of the following, but not limited to: a processor, a network element, a server, a computing device, a physical storage and a physical memory. Although the interactive voice response channel node 208, the self-service web portal node 210, the agent application node 212, the interactive voice response session manager node 214, the web session manger node 216, the agent session bridge manager node 218, the mediation manager node 222 and the analyzing and correlating manager node 224 are illustrated in FIG. 2 as being separate devices, it is noted that one or more applications are implementable on a single node or any subset of the nodes shown in FIG. 2.

A mediation manager node 222 is responsible for coordinating interactive sessions facilitated via a number of service channels to collect interactive dialogs and interactive data associated with interactive sessions for a communications center. The mediation manager node 222 stores the interactive dialog details and the interactive data in the current interaction data store 226 and facilitates data retrieval on behalf of session manager nodes 214, 216 and 218. Interactive data retrieved for session manager nodes 214, 216 and 218 includes “raw” recorded interactive session data. Data retrieved on behalf of analyzing and correlating manager node 224 includes a layer of data management functionality insofar as the analyzing and correlating manager node 224 is enabled to receive a complex data set from unified communication server 220. A customer 202 accesses interactive voice response system service channel capabilities by communicating via interactive voice response channel node 208, upon which an interactive voice response service channel application is implemented. Customer 204 access self-service capabilities of a web portal by communicating via self-service web portal node 210, upon which an self-service web portal application is implemented. Customer 230 accesses agent-enabled capabilities by communicating via agent 206 and agent application node 212, upon which an agent application is implemented.

Similarly, an interactive voice response session manager application is implemented on the interactive voice response session manager node 214, a web session manager application is implemented on the web session manager node 216, a mediation manager application is implemented on the mediation manager node 222, an agent session bridge manager application is implemented on the agent session bridge manager node 218, and an analyzing and correlating manager application is implemented on the analyzing and correlating manger node 224. The applications implemented on each of the nodes shown in FIG. 2 allow the nodes to perform the described functions. However, FIG. 2 will be described with reference to the illustrated nodes without reference to the applications implemented on the illustrated nodes, for clarity.

The analyzing and correlating manager node 224 interacts with current interaction data store 226 and historical interaction data store 228 via meditation manager node 222 to perform content correlation, when the mediation manager node 222 provides a notification to the analyzing and correlating manager node 224. If the analyzing and correlating manager node 224 finds a group of interactive data with similar content, the analyzing and correlating manager node 224 correlates the interactive data into a common, interactive session group and accumulated interactive data. Alternatively or additionally, when the analyzing and correlating manager node 224 detects that an interactive session group already has an associated solution or recommendation for a particular issue, the analyzing and correlating manager node 224 will provide the solution to the mediation manager node 222, which in turn provides the solution to an appropriate session manager node (i.e., any of interactive voice response system session manager node 214, web session manager node 216, and agent session bridge manager node 218).

The analyzing and correlating manager node 224 provides stored interactive data to an agent or a customer when the analyzing and correlating manager node 224 receives a request via the mediation manager node 222. The analyzing and correlating manager node 224 analyzes the interactive data, filters the interactive data based on relative importance of a portion of the interactive data and presents a result to the requester (i.e., the agent 206 or customers 202, 204 and 230).

The analyzing and correlating manager node 224 analyzes partially completed or partially captured interactive sessions to identify behavior patterns (e.g., customers abandoning a self-service channel for an agent-enabled channel) useful to customer care and marketing organizations to improve the sales and interaction dialogs. The analyzing and correlating manager node 224 also identifies a list of partially completed purchase transactions for which a predetermined time has lapsed, without a follow-up actions (e.g., the customer has not called back to purchase an originally desired item within 48 hours). Such reporting will enabled a sales organization to contact the customers to complete a purchase.

The current interaction data store 226 captures and stores interactive data associated with an interactive session in real-time. The current interaction data store 226 periodically sends a copy of the interactive session data, in the form of a live interaction log, to a historical interaction data store 228. When an interactive session is terminated smoothly, that is, upon resolution of an issue or subject of the interactive session, the current interaction data store 226 sends a log of the interactive session to the historical interaction data store 228, and the log of the interactive session is subsequently cleared from the current interaction data store 226. When an interactive session is terminated abruptly, that is, prior to resolution of an issue or subject of the interactive session, the current interaction data store 226 maintains a partially captured interactive session log for a predetermined period of time. If a new interactive session is re-initiated by a user, the current interaction data store 226 merges a previously recorded/stored interactive session log with an interactive session log for the newly re-initiated interactive session. However, if no new interactive session is re-initiated upon the expiration of the predetermined period of time, the current interaction data store 226 clears the interactive session log and moves the interactive session log to the historical interaction data store 228.

A unified communication server 220 allows a customer to bridge user artifacts to an interactive session. For example, when a customer initiates an interactive session from either an interactive voice response system service channel or an Internet-enabled, self-service channel and would like to bridge emails, voicemails, audio recordings, image files, text files, data files, video recordings, or any other multimedia files residing on the unified communication server 220 that are related to a subject of the interactive session, the mediation manger node 222 interacts with the unified communication server 220 to bridge the requested multimedia file with an interactive session log for the interactive session.

A historical interaction data store 228 stores interactive session logs for a number of service channels. The historical interaction data store 228 stores data according to rules defined by the analyzing and correlating manager node 224 by arranging the interactive session data, in one embodiment, in a condensed and more organized manner. In another embodiment, once an interactive session log is moved to the historical interaction data store, a customer 202, 204, or 230 requests to bridge or update the interactive session log stored in the historical interaction data store 228, when initiating a new session. If the customer 202, 204 or 230 does not request to bridge or update to a previously initiated interactive session, a new interactive session log is used to record the interactive session data. The interactive session log stored in the historical interaction store 228 is retrievable by an agent or a customer for review.

As described above, interactive session data is captured and stored, in the current interaction data store 226, as an interaction session log. For existing customers, the interactive session log is indexed and retrievable by a number of search keys including any of the following, but not limited to: an interaction identifier, an account identifier and a communication identifier such as a telephone number or an email address. In one embodiment, the email address is also associated with a timestamp. For potential or new customers, the interactive session log is indexable using any of the following, but not limited to: a temporary account identifier, a customer-provided telephone number, a customer-provided email address and a customer-provided name. When an interactive session ends, and a captured interactive session log is moved to the historical interaction data store 228, if the potential user becomes a customer and subsequently contacts the communications center, the current interaction data store 226 and the historical interaction data store 228 are searched and a temporary account identifier is replaced with a new customer account identifier.

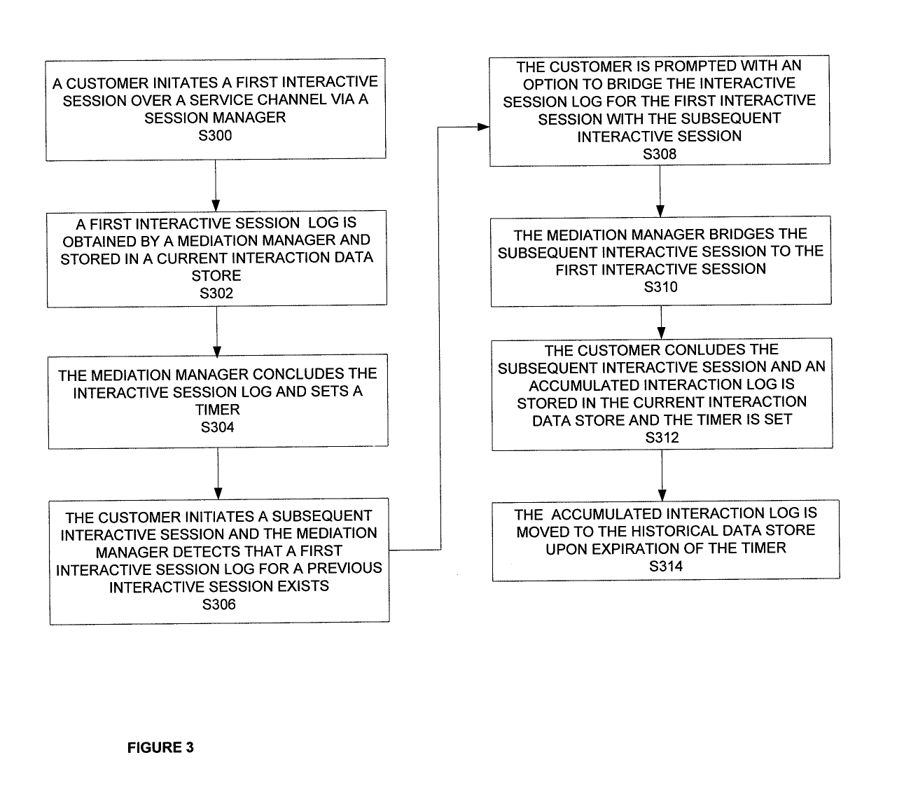

In FIG. 3, a process flow diagram according to a first embodiment of the present disclosure is shown. In step S300, a customer initiates an interactive session over a service channel and the interactive session is established via a session manager node. As will be understood by one of ordinary skill in the art, the following method operates independently of the service channel over which the customer contacts the communications center. In the exemplary embodiment, the customer initiates communication over an interactive voice response system service channel that is serviced by the interactive voice response system service manager node. In step S302, an interactive session log is obtained by the mediation manager node and stored in the current interaction data store. Also in step S302, the interactive session ends, abruptly or prior to resolution of the subject or issue the customer is communicating in regards to. In another embodiment, the interactive session ends smoothly, or upon resolution of the subject or issue the customer is communicating in regards to. The session manager node, an interactive voice response session manager node in the exemplary embodiment, detects the ending of the interactive session and directs the mediation manager node to conclude the interactive session log in step S304. Also in step S304, the mediation manager node concludes the interactive session log in the current interaction data store and sets a timer.

In step S306, the customer reinitiates communication by initiating a subsequent interactive session via either the same type of service channel or a different type of service channel, prior to expiration of the timer. In the exemplary embodiment, the customer reinitiates communication over an agent-enabled web service channel. In an alternative embodiment, the customer initiates the subsequent interactive session over the same type of service channel, that is, an interactive voice response system service channel. When the interactive voice response system session manager node begins to establish an interactive session log for the subsequent interactive session, the mediation manager node detects and/or retrieves a first interactive session log, for the first interactive session, that exists in the current interaction data store. In the exemplary embodiment, the first interactive session log is partially captured and represents an unresolved issue or incomplete first interactive session. In another embodiment, the first interactive session log is complete and represents an interactive session for which an associated subject or issue was resolved.

In step S308, the customer is prompted with an option to bridge the stored, first interactive session log with the subsequent interactive session. In one embodiment, when the customer chooses to bridge the subsequent interactive session with the stored, first interactive session log, the customer is prompted by the interactive voice response system indicating that an interactive session log for a partially completed or partially captured interactive session was stored earlier. In another embodiment, the interactive voice response system also indicates that the stored, first interactive session was ended or was stored, for example, five minutes earlier. In step S310, the mediation manager node bridges the subsequent interactive session with the stored, first interactive session log corresponding to the customer's first interactive session with the communications center. In this manner, the customer is presented with an option to continue the first interactive session from the point at which it was abandoned. In one embodiment, the customer may be given the option to review and/or confirm any previously abandoned interactive sessions irrespective of the service channel over which the previously abandoned interactive sessions were initiated or abandoned.

Also in step S310, the stored, first interactive session log for the first interactive session initiated in step S300 is correlated with and updated with interactive data associated with the subsequent interactive session (i.e., the subsequent interactive session initiated in step S306). In step S312, the customer concludes the subsequent interactive session and the session manager node directs the mediation manager node to conclude an accumulated interactive session log (i.e., that includes interactive session data associated with the customer's first interactive session initiated in step S300 and that includes interactive session data associated with the customer's subsequent interactive session initiated in step S306) stored in the current interaction data store and sets the timer. In one embodiment, the customer is offered an option to review an interactive session log and edit the interactive session log during a live interactive session. In another embodiment, when an interactive session ends, the customer is enabled to perform a subset of editing functions (e.g., writing, deleting, moving, copying) within a predetermined time (e.g., within two hours). After the predetermined time lapses, the interactive session log becomes read-only. In step S314, an accumulated interaction log is moved to the historical data store, upon expiration of the timer.

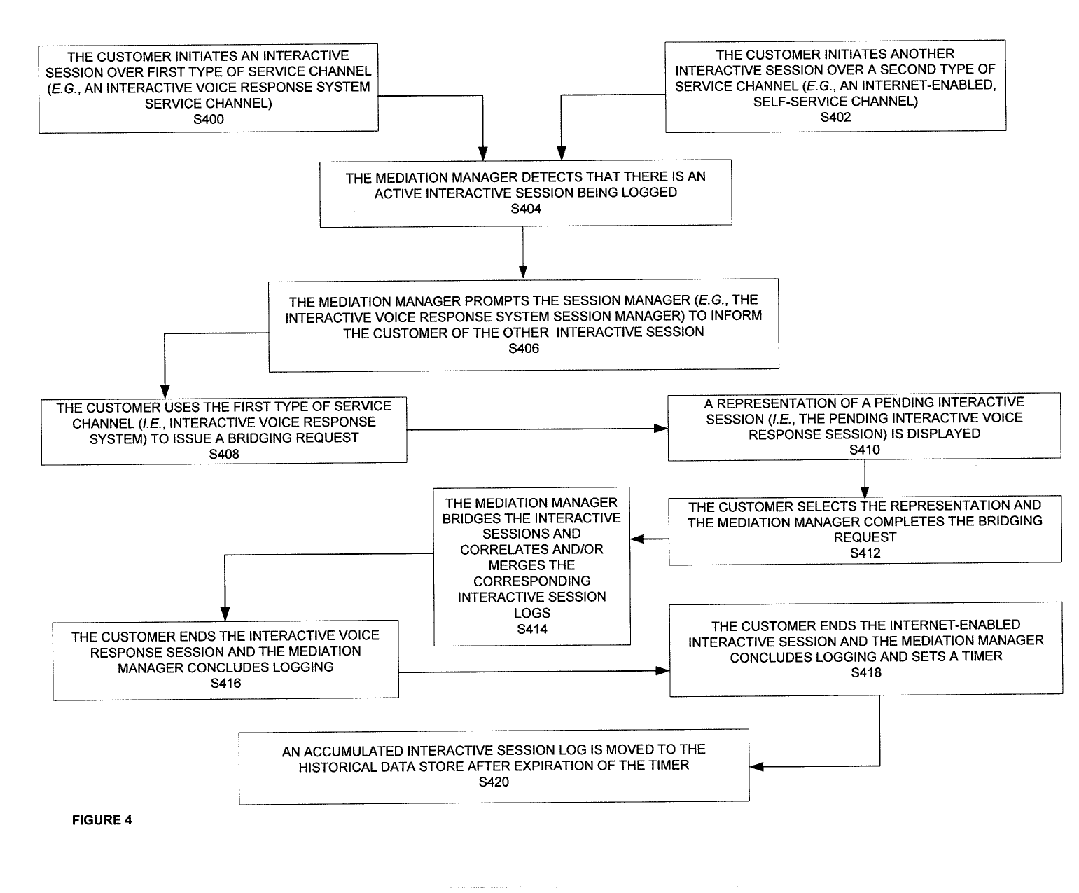

In FIG. 4, a process flow diagram according to a second embodiment of the present disclosure is shown. In this second embodiment of the present disclosure, the customer concurrently initiates multiple interactive sessions via one or more service channels. In step S400, the customer initiates an interactive session over a first type of service channel (e.g., an interactive voice response system service channel) and an interactive session is established via the interactive session manager node. Also in step S400, an interactive session log is collected by the mediation manager node and is sent to the current interaction data store. Concurrently with the interactive session being established over the interactive voice response system service channel, the customer initiates an interactive session over second type of service channel (e.g., an Internet-enabled, self-service channel) in step S402. In the exemplary embodiment, the customer performs diagnostics that are available over the Internet-enabled, self-service channel. In step S404, the mediation manager node detects that there is an active interactive session being logged. In step S406, the mediation manager node prompts the session manager node (i.e., the interactive voice response system session manager node) to inform the customer that an interactive session via a Internet-enabled, self-service channel has also been initiated.

The customer uses an interactive voice response system interaction menu to issue a bridging request and the interactive session enters a “bridge pending” state, in step S408. A representation of the pending interactive session, i.e., the interactive voice response session, is displayed (e.g., in a web dropdown menu) in the interactive session via the Internet-enabled, self-service channel, in step S410. In an alternative embodiment, the customer requests to enter a “bridge pending” state by issuing a bridging request from the Internet-enabled, self-service channel. The mediation manager node completes the bridging request, once the customer selects the representation of the pending interactive session from the web dropdown menu display, in step S412. In an alternative embodiment, the customer selects the representation of a pending interactive session from an interactive voice response system interaction menu. In step S414, the mediation manager node bridges the Internet-enabled interactive session to the interactive voice response session. In this manner, the customer is able to view interactions for both interactive sessions occurring until the current time, by displaying the interactive voice response session log on a single display via the Internet-enabled, self-service channel. In this manner, a customer is enabled to keep multiple interactive sessions open at the same time, and is also enabled to terminate either interactive session.

Also in step S414, the corresponding interactive session logs, (i.e., the interactive voice response session log and the Internet-enabled interactive session log) are correlated with each other in the current interaction data store. In one embodiment, the interactive voice response session log is merged with the Internet-enabled interactive session log to form an accumulated interactive session log. In another embodiment, the accumulated session log is updated with both interaction data from the interactive voice response session and interactive data from the web interactive session, upon merging into the accumulated session log.

The customer ends the interactive voice response session and the interactive voice response system session manager node directs the mediation manager node to conclude logging interactive data to the accumulated session log, in step S416. In one embodiment in which the interactive voice response session log and the Internet-enabled interactive session log are not merged, the interactive voice response session log is concluded. In step S418, the customer ends the Internet-enabled interactive session log and the mediation manager node concludes logging to the accumulated session log, in step S418. In one embodiment in which the interactive voice response session log and the Internet-enabled interactive session log are not merged, the Internet-enabled interactive session log is concluded. Also in step S418, the mediation manager node sets a timer. In step S420, after expiration of the timer, the accumulated interactive session log is moved to the historical interaction data store. In an embodiment in which the interactive voice response session log and the Internet-enabled interactive session log are correlated but not merged, they are both moved to the historical data store and are stored as being associated with a common interactive session log group.

In one non-limiting example, customer A uses an interactive voice response system service channel to report a video-related problem. At some point during the interactive session, her daughter plays the piano and the music interferes with the interactive session over the interactive voice response system service channel. Customer A launches a self-service web interactive session and directs the interactive voice response session to be bridged with the self-service web interactive session. Customer A mutes the interactive voice response session and starts to use the self-service web interactive session to continue the reporting process. As soon as her daughter finishes playing the piano, Customer A switches back to the interactive voice response session and terminates the self-service web interactive session. Interactive data sent over both service channels is stored in the interactive voice response session log.

Although the present specification describes components and functions that may be implemented in particular embodiments with reference to particular standards and protocols, the disclosure is not limited to such standards and protocols. For example, standards for Internet and other packed switched network transmission, application messaging and data storage represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for managing communications received at a communications center, comprising:
receiving at the communications center, a communication from a user initiated via a first interactive session over a first service channel;
storing, in at least one database, first interaction data associated with the first interactive session, either concurrently with the first interactive session or upon termination of the first interactive session; and
retrieving, by at least one processor, the first interaction data when a subsequent interactive session is initiated, by either of the user or an agent, via at least one of the first service channel and a second service channel and subsequent interaction data is obtained.

2. The method according to claim 1,
wherein an interactive dialog initiated in the first interactive session is resumed in the subsequent interactive session.

3. The method according to claim 1, further comprising:
correlating the first interaction data with the subsequent interaction data when the subsequent interaction data is obtained prior to expiration of a timer associated with the first interaction data.

4. The method according to claim 1,
wherein the first service channel comprises a self-service channel, and
wherein the second service channel comprises an agent-enabled service channel.

5. The method according to claim 1,
wherein the user switches between the first interactive session and the subsequent interactive session.

6. The method according to claim 1, further comprising:
merging the first interaction data with the subsequent interaction data in the at least one database.

7. The method according to claim 4,
wherein the self-service channel is one of: an interactive voice response system service channel, an email submission service channel, and a web form submission service channel, and
wherein the agent-enabled service channel is one of: an agent-enabled chat client and an agent-enabled call.

8. The method according to claim 1, further comprising:
bridging the first interactive session with the subsequent interactive session, when the subsequent interactive session is initiated concurrently with the first interactive session.

9. The method according to claim 1, further comprising:
storing accumulated interaction data in a historical interaction database upon expiration of a timer,
wherein the accumulated interaction data comprises the first interaction data and the subsequent interaction data.

10. The method according to claim 9, further comprising:
searching the historical interaction database, concurrently with servicing a subsequent communication received at the communications center, to obtain interaction data related to a subject of the subsequent communication.

11. The method according to claim 10, further comprising:
preparing an interactive dialog for at least one of a self-service channel and an agent-enabled service channel based on the interaction data related to the subject of the subsequent communication.

12. The method according to claim 1,
wherein the first interaction data and the subsequent interaction data each comprise at least one of: user input, system data, agent input and a user artifact.

13. The method according to claim 12,
wherein system data comprises at least one of: data retrieved by an application supporting at least one of the first service channel and the second service channel, data generated by the application, data obtained from a test performed by at least one of the first service channel and the second service channel, and data obtained from a test triggered by at least one of the first service channel and the second service channel during at least one of the first interactive session and the second interactive session.

14. The method according to claim 12,
wherein the user artifact comprises at least one of: a video file, an audio recording, a text file, a data file and an image file.

15. The method according to claim 1,
wherein the first interactive session terminates prior to resolving a subject of the communication, and
wherein the subsequent interactive session is initiated by the user to resume the communication initiated in the first interactive session.

16. The method according to claim 1,
wherein the first interactive data and the second interactive data are each editable during a predetermined period of time, and
wherein the first interactive data and the subsequent interactive data are each reviewable after the predetermined period of time.

17. The method according to claim 6, further comprising:
updating the first interaction data with the subsequent interaction data in the at least one database.

18. The method according to claim 3,
wherein correlating the first interaction data with the subsequent interaction data precludes unnecessary record retrieval for the user.

19. A system for managing communications received at a communications center, comprising:
a receiver that receives, at the communications center, a communication from a user initiated via a first interactive session over a first service channel;
at least one database, that stores first interaction data associated with the first interactive session, either concurrently with the first interactive session or upon termination of the first interactive session; and
a retriever that retrieves the first interaction data when a subsequent interactive session is initiated, by either of the user or an agent, via at least one of the first service channel and a second service channel and subsequent interaction data is obtained.

20. A tangible computer readable medium, that stores a computer program for managing communications received at a communications center, comprising:
a receiving code segment, recorded on the tangible computer readable medium, that receives at the communications center, a communication from a user initiated via a first interactive session over a first service channel;
a storing code segment, recorded on the tangible computer readable medium, that stores, in at least one database, first interaction data associated with the first interactive session, either concurrently with the first interactive session or upon termination of the first interactive session; and
a retrieving code segment, recorded on the tangible computer readable medium, that retrieves, by at least one processor, the first interaction data when a subsequent interactive session is initiated, by either of the user or an agent, via at least one of the first service channel and a second service channel and subsequent interaction data is obtained.
